(19) United States
(12) Patent Application Publication
(10) Pub. No.: US 2026/0050543 A1
(43) Pub. Date: Feb. 19, 2026

(54) COMPUTE-IN-MEMORY SYSTEMS AND METHODS WITH WEIGHT UPDATE CIRCUITS

(71) Applicant: Taiwan Semiconductor Manufacturing Company, Ltd., Hsinchu (TW)

(72) Inventors: Yu-Der CHIH, Hsinchu (TW); Haruki MORI, Hsinchu (TW); Je-Min HUNG, Hsinchu (TW); Chia-Fu LEE, Hsinchu (TW); Hidehiro FUJIWARA, Hsinchu (TW); Jonathan TSUNG-YUNG CHANG, Hsinchu (TW)

(21) Appl. No.: 18/802,824

(22) Filed: Aug. 13, 2024

(51) Int. Cl. G06F 12/02; G06F 7/544

(52) U.S. Cl. CPC G06F 12/0223; G06F 7/5443

(57) ABSTRACT

A device includes a memory array to store a plurality of weight sets and read circuits to read the plurality of weight sets. A first weight buffer is to store a first weight set of the plurality of weight sets and a write driver circuit is to write the first weight set into the first weight buffer during a single write clock cycle. A plurality of first multiplier circuits receives the first weight set from the first weight buffer and a first data input set of data input channels 0-N. Each of the first multiplier circuits is to receive a corresponding first weight of the first weight set and a first data input of the first data input set and to multiply the first weight and the first data input to provide a partial product. An adder tree is to sum the partial products and provide an accumulated result.

### BACKGROUND

Compute-in-memory (CIM) systems and methods store information in memory, such as random-access memory (RAM), of a memory device and perform calculations in the memory device, as opposed to moving data between the memory device and another device for various computational steps. The stored data is accessed more quickly from the memory device than from other storage devices. Also, the stored data is analyzed more quickly in the memory device, which enables faster calculations in machine learning applications, such as large language models (LLMs) and convolutional neural networks (CNNs).

LLMs and CNNs are artificial neural networks. LLMs specialize in general-purpose language understanding and generation. LLMs acquire abilities by learning statistical relationships from text documents during an intensive training process. Attention mechanism LLMs are inspired by human cognitive processes, where the attention mechanism LLMs selectively focus on specific parts of the input data, enhancing their ability to understand and generate human-like text. In contrast to this, CNNs specialize in processing data that has a grid-like topology, such as digital image data that includes binary representations of visual images. The digital image data includes pixels arranged in a grid-like topology, which contain values denoting image characteristics, such as color and brightness. Efforts are ongoing to improve the performance of CIM systems.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion. In addition, the drawings are illustrative as examples of embodiments of the disclosure and are not intended to be limiting.

FIG. 1 is a diagram schematically illustrating a memory device configured to improve the weight update efficiency for MAC operations, in accordance with some embodiments.

FIG. 2 is a diagram schematically illustrating an SRAM memory array electrically coupled to memory device circuits, in accordance with some embodiments.

FIG. 3 is a diagram schematically illustrating an example of a CIM memory device that includes CIM circuits electrically coupled to a memory array in the CIM memory device, in accordance with some embodiments.

FIG. 4 is a diagram schematically illustrating an SRAM cell that can be used in a memory array for storing neural network weights, in accordance with some embodiments.

FIG. 5 is a diagram schematically illustrating a CIM circuit that is configured to improve the weight update efficiency of a memory device for MAC operations, in accordance with some embodiments.

FIG. 6 is a diagram schematically illustrating signals for writing a weight set of N+1 weights W into one of the weight buffer circuits during a single write clock cycle, in accordance with some embodiments.

FIG. 7 is a diagram schematically illustrating a CIM circuit that includes a multiple row weight buffer, in accordance with some embodiments.

FIG. 8 is a diagram schematically illustrating a CIM circuit that includes storage circuits, a zero skip circuit, and an all zero flag circuit, in accordance with some embodiments.

FIG. 9 is a diagram schematically illustrating a method of operating a neural network device, in accordance with some embodiments.

FIG. 10 is a block diagram schematically illustrating an example of a computer system configured to provide the electronic devices, semiconductor devices, and methods of the current disclosure, in accordance with some embodiments.

FIG. 11 is a block diagram of a semiconductor device manufacturing system and a semiconductor device manufacturing flow associated therewith, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Often, artificial neural networks perform convolutions that include many multiply and accumulate (MAC) operations. For example, both LLMs and CNNs perform many MAC operations, where attention mechanism LLMs can include both conventional matrix convolution and transposed matrix convolution. In a MAC operation, a data input set is multiplied by a weight set to provide partial products that are added together to provide an accumulated result. For example, a data input set of data input channels 0-N is multiplied by a weight set of N+1 weights. Each of the data input channels 0-N is multiplied by one of the weights in the weight set of N+1 weights to provide a partial product. These partial products are added together to provide the accumulated result. The weight sets are updated to perform other MAC operations. However, these systems suffer from a low weight update efficiency, where one weight in a weight set is updated per clock cycle and it takes N+1 clock cycles to update an entire weight set. In some systems, writing one weight in a weight set per clock cycle, where it takes N+1 clock cycles to update an entire weight set, is a channel first write in a conventional write update.

Disclosed embodiments provide a device that improves the weight update efficiency for MAC operations. The device includes a memory array that stores weight sets used in an artificial neural network and read circuits configured to read the weight sets out of the memory array. A first weight buffer is configured to store one weight set of the weight sets, and a write driver circuit is configured to write the one weight set into the first weight buffer during a single write clock cycle. The device further includes first multiplier circuits configured to receive the one weight set from the first weight buffer and a first data input set of data input channels 0-N, wherein each of the first multiplier circuits is configured to receive one weight of the one weight set and one data input of the first data input set and to multiply the one weight and the one data input to provide a partial product. An adder tree is configured to sum the partial products from the first multiplier circuits and provide an accumulated result. In some systems, writing an entire weight set into a weight buffer during a single write clock cycle is a channel last weight update sequence.

In some embodiments, the device includes a second weight buffer configured to store another weight set of the weight sets, and the write driver circuit is configured to write the other weight set into the second weight buffer during another single write clock cycle. Second multiplier circuits are configured to receive the other weight set from the second weight buffer and a second data input set of data input channels 0-N, wherein each of the second multiplier circuits is configured to receive one weight of the other weight set and one data input of the second data input set and to multiply the one weight of the other weight set and the one data input of the second data input set to provide a partial product. An adder tree is configured to sum the partial products from the second multiplier circuits and provide an accumulated result.

In some embodiments, the device includes a multiple row weight buffer, wherein each row of the multiple row weight buffer is a different weight buffer that is configured to store a weight set of the weight sets. A write driver circuit is configured to write a weight set into a row of the multiple row weight buffer in a single clock cycle. Multiplier circuits are configured to receive the weight set from a row of the multiple row weight buffer and a data input set of data input channels 0-N. Each of the multiplier circuits is configured to receive one weight of the weight set and one data input of the data input set and to multiply the one weight and the one data input to provide a partial product. An adder tree is configured to sum the partial products from the multiplier circuits and provide an accumulated result. This is or can be repeated for each row of the multiple row weight buffer.

Disclosed embodiments further provide a method of operating a neural network device that includes storing weight sets, used in a neural network, in a memory array; reading, by read circuits, the weight sets out of the memory array; writing, by a write driver circuit, one weight set of the weight sets into a weight buffer during a single write clock cycle; multiplying, by multiplier circuits, the one weight set from the weight buffer and a data input set of data input channels 0-N, wherein each of the multiplier circuits is configured to receive one weight of the one weight set and one data input of the data input set and to multiply the one weight and the one data input to provide a partial product; and adding, by an adder tree, the partial products from the multiplier circuits to provide an accumulated result.

Advantages of the device include updating a weight set in a weight buffer in a single clock cycle, as opposed to multiple clock cycles, which improves the weight update efficiency of the device for MAC operations.

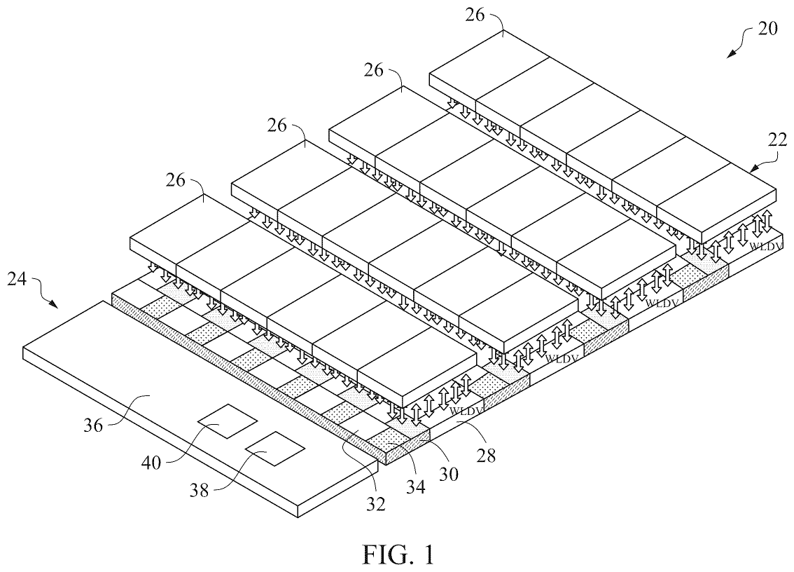

FIG. 1 is a diagram schematically illustrating a memory device 20 configured to improve the weight update efficiency for MAC operations, in accordance with some embodiments. The memory device 20 includes a memory array 22 situated above or on top of memory device circuits 24. The memory device 20 is a CIM device that includes memory device circuits 24 configured to provide functions for applications, such as LLM applications and/or CNN applications. In some embodiments, the memory device 20 includes a memory array 22 that is a back-end-of-line (BEOL) memory array situated above memory device circuits 24 that are front-end-of-line (FEOL) circuits. In other embodiments, the memory array 22 can be situated on the same level or below/underneath the memory device circuits 24.

The memory array 22 is a static random-access memory (SRAM) memory array including multiple SRAM memory arrays 26. In other embodiments, the memory array 22 can be a different type of memory array, such as an RRAM array, an MRAM array, and a PCRAM array. In still other embodiments, the memory array 22 can be a dynamic random-access memory (DRAM) array.

The memory device circuits 24 include word line drivers (WLDVs) 28, sense amplifiers (SAs) 30, column select (CS) circuits 32, read circuits 34, and CIM circuits 36. The WLDVs 28 and the SAs 30 are situated directly under the SRAM memory arrays 26 and electrically coupled to the SRAM memory arrays 26. The CS circuits 32 and the read circuits 34 are situated between the footprints of the SRAM memory arrays 26 and electrically coupled to the SAs 30. Each of the read circuits 34 includes a read port electrically coupled to the CIM circuits 36 that are configured to receive data from the read ports.

The CIM circuits 36 include circuits that perform functions of supported applications, such as LLM applications and/or CNN applications. In some embodiments, the CIM circuits 36 include weight buffer circuits 38 and MAC circuits 40 configured to provide accumulated results. In some embodiments, the CIM circuits 36 perform functions of an LLM. In some embodiments, the CIM circuits 36 perform functions of a CNN.

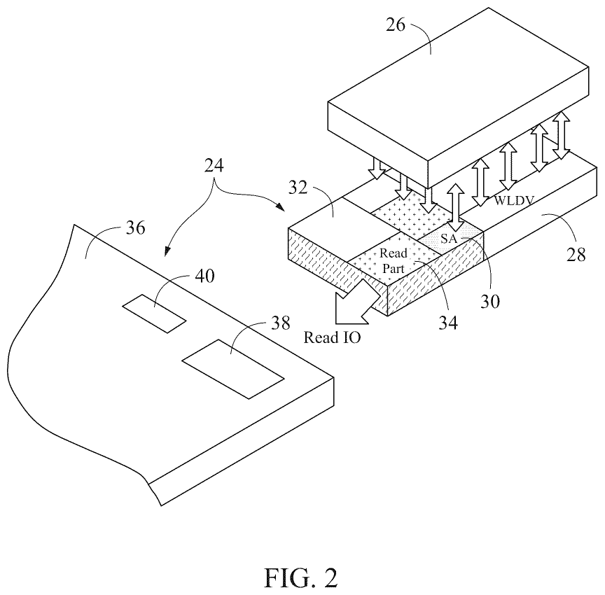

FIG. 2 is a diagram schematically illustrating an SRAM memory array 26 electrically coupled to memory device circuits 24, in accordance with some embodiments. The memory device circuits 24 include a WLDV 28 and a SA 30 situated directly underneath and electrically coupled to the SRAM memory array 26. Also, the memory device circuits 24 include a CS circuit 32 and a read circuit 34 electrically coupled to the SA 30 and situated adjacent a footprint of the SRAM memory array 26. In addition, the memory device circuits 24 include the CIM circuits 36 that include the weight buffer circuits 38 and the MAC circuits 40.

During a read operation, the SA 30 senses voltages from memory cells in the SRAM memory array 26 and the read circuit 34 obtains voltages from the SA 30 that correspond to the voltages sensed from the memory cells in the SRAM memory array 26. The WLDV 28 and the CS circuit 32 provide signals for reading the SRAM memory array 26 and the read circuit 34 outputs voltages at the read port that correspond to the voltages read from the SA 30 by the read circuit 34. The CIM circuits 36 receive the output voltages from the read port and perform functions of the memory device 20, such as functions for an LLM application and/or functions for a CNN application. During a write operation, the WLDV 28 and the CS circuit 32 provide signals for writing the SRAM memory array 26, and the SA 30 receives data that is written into the SRAM memory array 26. In some embodiments, the read circuit 34 is part of the SA 30. In some embodiments, the read circuit 34 is a separate circuit that is electrically connected to the SA 30.

The read circuit 34 provides output voltages through the read port that correspond to the voltages read from the SA 30 and the SRAM memory array 26. In some embodiments, the read port provides output voltages directly to the weight buffer circuits 38. In some embodiments, the read port provides output voltages directly to other circuits in the CIM circuits 36, i.e., circuits other than the weight buffer circuits 38.

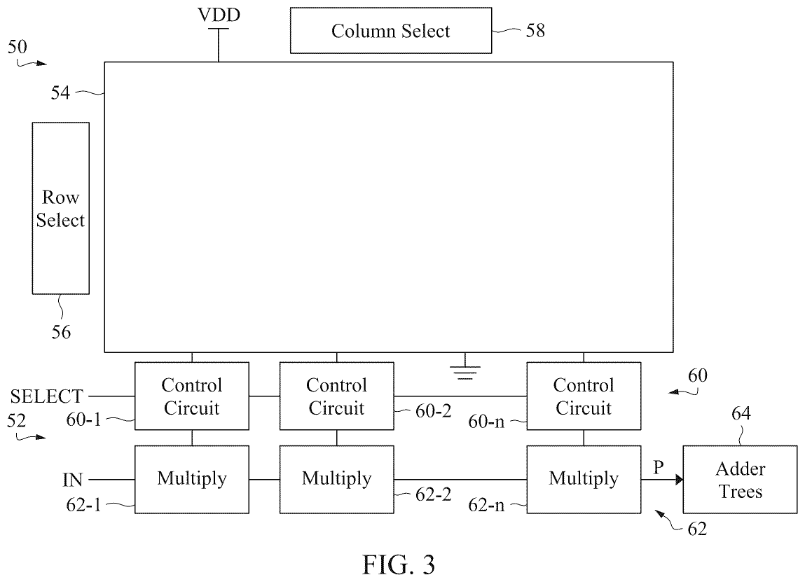

FIG. 3 is a diagram schematically illustrating an example of a CIM memory device 50 that includes CIM circuits 52 electrically coupled to a memory array 54 in the CIM memory device 50, in accordance with some embodiments. In some embodiments, the CIM memory device 50 is like the memory device 20 of FIG. 1. In some embodiments, the CIM circuits 52 are configured to provide functions for applications, such as LLM applications and/or CNN applications. In some embodiments, the memory array 54 is a BEOL memory array situated above the CIM circuits 52 that are FEOL circuits.

In this example, the memory array 54 includes a plurality of memory cells that store neural network weights. The memory array 54 and the associated circuits are connected between a power terminal configured to receive a VDD voltage and a ground terminal. A row select circuit 56 and a column select circuit 58 are connected to the memory array 54 and configured to select memory cells in rows and columns of the memory array 54 during read and write operations.

The memory array 54 includes a control circuit 60 connected to bit lines of the memory array 54 and configured to select memory cells in response to a select signal SELECT. The control circuit 60 includes control circuits 60-1, 60-2 . . . 60-n connected to the memory array 54. In some embodiments, the control circuit 60 includes at least one write driver circuit and the weight buffer circuits 38.

The CIM circuits 52 include a multiply circuit 62 and at least one adder tree 64. An input terminal is configured to receive an input signal IN, and the multiply circuit 62 is configured to multiply the neural network weights stored in the memory array 54 by the input signal IN to generate a plurality of partial products P. The multiply circuit 62 includes multiply circuits 60-1, 60-2 . . . 60-n. The partial products P are output to the at least one adder tree 64 that is configured to add the partial products P and provide an accumulated result.

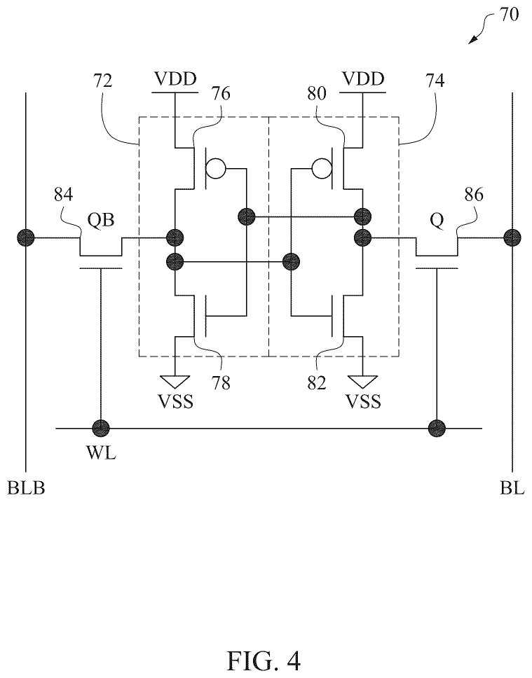

FIG. 4 is a diagram schematically illustrating an SRAM cell 70 that can be used in a memory array for storing neural network weights, in accordance with some embodiments. The SRAM cell 70 is a six-transistor (6T) SRAM cell. In some embodiments, the SRAM cell 70 is used in the memory device 20 of FIG. 1. In some embodiments, the SRAM cell 70 is used in the CIM memory device 50 of FIG. 3. In some embodiments, the SRAM cell 70 is used in the memory array 54 shown in FIG. 3. In other embodiments, the SRAM cell 70 can include more or fewer than six transistors, such as four, eight, or ten transistors.

The SRAM cell 70 includes two cross-coupled inverters 72 and 74. The first inverter 72 includes a first PMOS/NMOS transistor pair 76 and 78, and the second inverter 74 includes a second PMOS/NMOS transistor pair 80 and 82. The SRAM cell 70 further includes a left pass gate transistor 84 and a right pass gate transistor 86.

Power is supplied to each of the inverters 72 and 74, where a first terminal of each of a left pull-up transistor 76 and a right pull-up transistor 80 is electrically coupled to a power supply VDD, and a first terminal of each of a left pull-down transistor 78 and a right pull-down transistor 82 is electrically coupled to a reference voltage VSS, such as ground. A bit of data is stored in the SRAM cell 70 as a voltage at node Q and can be read through the right pass gate transistor 86 via the bit line BL, where access to the node Q is controlled by the right pass gate transistor 86. The node Q bar (QB) stores the complement of the value at node Q, such that if Q is high then QB is low and vice-versa. The node QB can be read through the left pass gate transistor 84 via the bit line bar BLB, where access to the node QB is controlled by the left pass gate transistor 84.

A gate of the left pass gate transistor 84 is coupled to a word line WL. A first source/drain (S/D) terminal of the left pass gate transistor 84 is coupled to the bit line bar BLB, and a second S/D terminal of the left pass gate transistor 84 is coupled to the second terminals of the left pull-up transistor 76 and the left pull-down transistor 78 at the node QB and to the gates of the right pull-up transistor 80 and the right pull-down transistor 82.

Also, a gate of the right pass gate transistor 86 is coupled to the word line WL. A first S/D terminal of the right pass gate transistor 86 is coupled to the bit line BL, and a second S/D terminal of the right pass gate transistor 86 is coupled to second terminals of right pull-up transistor 80 and right pull-down transistor 82 at the node Q and to the gates of the left pull-up transistor 76 and the left pull-down transistor 78.

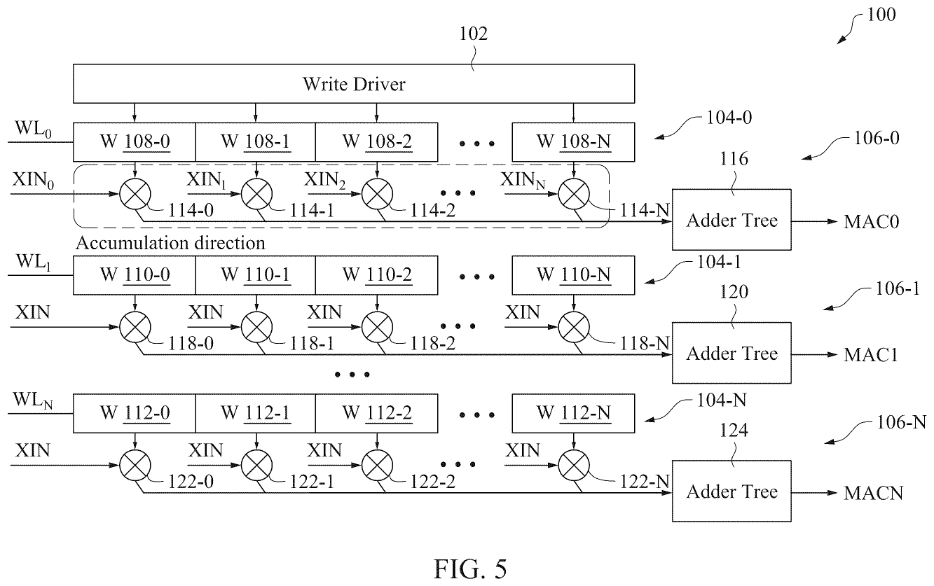

FIG. 5 is a diagram schematically illustrating a CIM circuit 100 that is configured to improve the weight update efficiency of a memory device for MAC operations, in accordance with some embodiments. The CIM circuit 100 includes a write driver circuit 102, weight buffer circuits 104-0, 104-1, and up to 104-N, and MAC circuits 106-0, 106-1, and up to 106-N. In some embodiments, the memory device is like the memory device 20 of FIG. 1. In some embodiments, the memory device is like the CIM memory device 50 of FIG. 3. In some embodiments, the CIM circuit 100 is like the CIM circuit 36 shown in FIG. 1. In some embodiments, the CIM circuit 100 is like the CIM circuit 52 shown in FIG. 3. In some embodiments, the weight buffer circuits 104-0, 104-1, and up to 104-N are like the weight buffer circuits 38 shown in FIG. 1. In some embodiments, the MAC circuits 106-0, 106-1, and up to 106-N are like the MAC circuits 40 shown in FIG. 1.

The weight buffer circuit 104-0 includes weight buffers 108-0, 108-1, 108-2, and up to 108-N. The weight buffer circuit 104-1 includes weight buffers 110-0, 110-1, 110-2, and up to 110-N, and up to the weight buffer circuit 104-N that includes weight buffers 112-0, 112-1, 112-2, up to 112-N. Also, the MAC circuit 106-0 includes multipliers 114-0, 114-1, 114-2, and up to 114-N and adder tree 116. The MAC circuit 106-1 includes multipliers 118-0, 118-1, 118-2, and up to 118-N and adder tree 120, and up to the MAC circuit 106-N includes multipliers 122-0, 122-1, 122-2, and up to 122-N and adder tree 124.

A memory array, such as memory array 22 or memory array 54, stores weight sets used in a neural network and read circuits read the weight sets out of the memory array. The CIM circuit 100 receives weight sets that each include N+1 weights W from the memory array. Each of the weight buffer circuits 104-0, 104-1, and up to 104-N is configured to store one weight set of the weight sets, and the write driver circuit 102 is configured to be connected to each of the weight buffer circuits 104-0, 104-1, and up to 104-N to write a weight set of N+1 weights W into each of the weight buffer circuits 104-0, 104-1, and up to 104-N. In some embodiments, the memory array is an SRAM memory array. In some embodiments, the weights are for one of an LLM, an attention mechanism LLM, or a CNN.

The write driver circuit 102 writes a weight set of N+1 weights W into the weight buffers 108-0, 108-1, 108-2, and up to 108-N during a single write clock cycle. To do this, word line WL₀ is activated, and the weight set of N+1 weights W is written into the weight buffers 108-0, 108-1, 108-2, and up to 108-N during the single write clock cycle. The weight buffers 108-0, 108-1, 108-2, and up to 108-N are electrically connected to the multipliers 114-0, 114-1, 114-2, and up to 114-N, respectively, and the multipliers 114-0, 114-1, 114-2, and up to 114-N receive data inputs XIN₀, XIN₁, XIN₂, and up to XIN_{N,} respectively. Each of the multipliers 114-0, 114-1, 114-2, and up to 114-N is configured to receive one weight W of the weight set of N+1 weights and one data input of the data inputs XIN₀, XIN₁, XIN₂, and up to XIN_{N} and to multiply the one weight W and the one data input of the data inputs XIN₀, XIN₁, XIN₂, and up to XIN_{N} to provide a partial product. The adder tree 116 receives and sums the partial products from the multipliers 114-0, 114-1, 114-2, and up to 114-N and provides an accumulated result MAC0.

Further, the write driver circuit 102 writes the same or another weight set of N+1 weights W into the weight buffers 110-0, 110-1, 110-2, and up to 110-N of weight buffer circuit 104-1 during a single write clock cycle. To do this, word line WL₁ is activated, and the weight set of N+1 weights W is written into the weight buffers 110-0, 110-1, 110-2, and up to 110-N during the single write clock cycle. The weight buffers 110-0, 110-1, 110-2, and up to 110-N are electrically connected to the multipliers 118-0, 118-1, 118-2, and up to 118-N, respectively, and the multipliers 118-0, 118-1, 118-2, and up to 118-N receive the same or another set of data inputs XIN₀, XIN₁, XIN₂, and up to XIN_{N,} respectively. Each of the multipliers 118-0, 118-1, 118-2, and up to 118-N is configured to receive one weight W of the weight set of N+1 weights and one data input of the data inputs XIN₀, XIN₁, XIN₂, and up to XIN_{N} and to multiply the one weight W and the one data input of the data inputs XIN₀, XIN₁, XIN₂, and up to XIN_{N} to provide a partial product. The adder tree 120 receives and sums the partial products from the multipliers 118-0, 118-1, 118-2, and up to 118-N and provides an accumulated result MAC1.

This continues up to the write driver circuit 102 writing the same or another weight set of N+1 weights W into the weight buffers 112-0, 112-1, 112-2, and up to 112-N of weight buffer circuit 104-N during a single write clock cycle. To do this, word line WL_{N} is activated, and the weight set of N+1 weights W is written into the weight buffers 112-0, 112-1, 112-2, and up to 112-N during the single write clock cycle. The weight buffers 112-0, 112-1, 112-2, and up to 112-N are electrically connected to the multipliers 122-0, 122-1, 122-2, and up to 122-N, respectively, and the multipliers 122-0, 122-1, 122-2, and up to 122-N receive the same or another set of data inputs XIN₀, XIN₁, XIN₂, and up to XIN_{N,} respectively. Each of the multipliers 122-0, 122-1, 122-2, and up to 122-N is configured to receive one weight W of the weight set of N+1 weights and one data input of the data inputs XIN₀, XIN₁, XIN₂, and up to XIN_{N} and to multiply the one weight W and the one data input of the data inputs XIN₀, XIN₁, XIN₂, and up to XIN_{N} to provide a partial product. The adder tree 124 receives and sums the partial products from the multipliers 122-0, 122-1, 122-2, and up to 122-N and provides an accumulated result MACN.

Advantages of the CIM circuit 100 include updating an entire weight set into a weight buffer in a single write clock cycle, as opposed to multiple write clock cycles, which improves the weight update efficiency of the memory device for MAC operations.

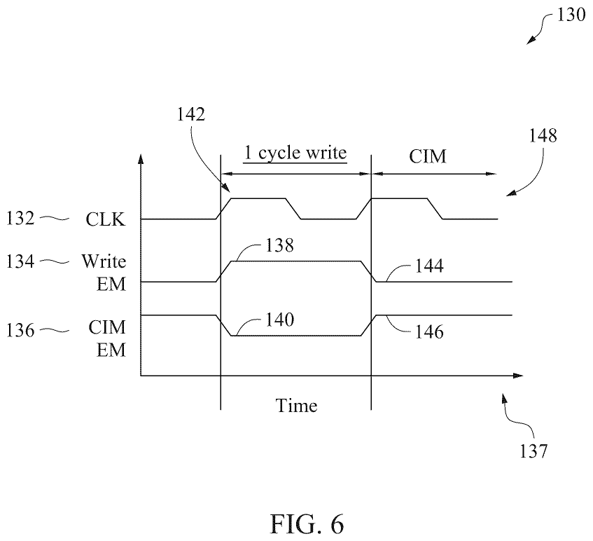

FIG. 6 is a diagram schematically illustrating signals 130 for writing a weight set of N+1 weights W into one of the weight buffer circuits 104-0, 104-1, and up to 104-N during a single write clock cycle, in accordance with some embodiments. The signals 130 include a clock signal 132, a write enable signal 134, and a CIM enable signal 136 versus time on the x-axis 137.

In operation, the write enable signal 134 goes to a high voltage level 138 to enable writing the weight set into one of the weight buffer circuits 104-0, 104-1, and up to 104-N. The CIM enable signal 136 goes to a low voltage level 140 to disable performing CIM circuit operations. The clock signal 132 includes a single write clock cycle 142 that goes to a high voltage level and back to a low voltage level to clock the weight set into the one of the weight buffer circuits 104-0, 104-1, and up to 104-N during the single write clock cycle 142. In some embodiments, the write enable signal 130 is the word line signal WLₓ.

Next, the write enable signal 134 goes to a low voltage level 144 to disable writing weight sets into the weight buffer circuits 104-0, 104-1, and up to 104-N, and the CIM enable signal 136 goes to a high voltage level 146 to enable performing the CIM circuit operations. The clock signal 132 includes one or more clock cycles 148 that each go to high voltage level and back to a low voltage level to perform the CIM circuit operations and store the accumulated results, such as storing the accumulated results in an accumulator (not shown).

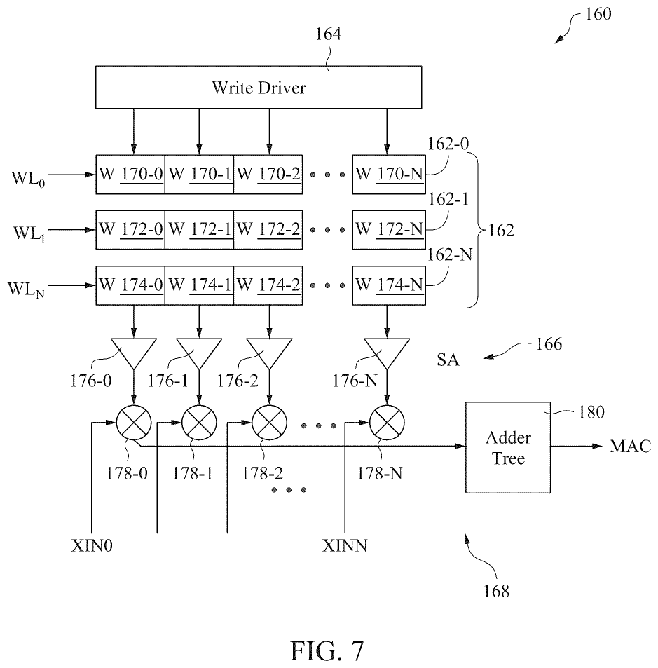

FIG. 7 is a diagram schematically illustrating a CIM circuit 160 that includes a multiple row weight buffer 162, in accordance with some embodiments. The CIM circuit 160 improves the weight update efficiency of a memory device for MAC operations. The multiple row weight buffer 162 includes weight buffer circuits 162-0, 162-1, and up to 162-N, where each row of the multiple row weight buffer 162 is a different one of the weight buffer circuits 162-0, 162-1, and up to 162-N that is configured to store a weight set of N+1 weights W.

The CIM circuit 160 includes a write driver circuit 164, the multiple row weight buffer 162 that includes the weight buffer circuits 162-0, 162-1, and up to 162-N, sense amplifiers 166, and a MAC circuit 168. The write driver circuit 164 writes a weight set of N+1 weights W into a row of the multiple row weight buffer 162 during a single clock cycle. In some embodiments, the memory device is like the memory device 20 of FIG. 1. In some embodiments, the memory device is like the CIM memory device 50 of FIG. 3. In some embodiments, the CIM circuit 160 is like the CIM circuit 36 shown in FIG. 1. In some embodiments, the CIM circuit 160 is like the CIM circuit 52 shown in FIG. 3. In some embodiments, the weight buffer circuits 162-0, 162-1, and up to 162-N are like the weight buffer circuits 38 shown in FIG. 1. In some embodiments, the MAC circuit 168 is like the MAC circuit 40 shown in FIG. 1.

The weight buffer circuit 162-0 includes weight buffers 170-0, 170-1, 170-2, and up to 170-N. The weight buffer circuit 162-1 includes weight buffers 172-0, 172-1, 172-2, and up to 172-N, and up to the weight buffer circuit 162-N that includes weight buffers 174-0, 174-1, 174-2, and up to 174-N. Also, the sense amplifiers 166 include sense amplifiers 176-0, 176-1, 176-2, and up to 176-N. In addition, the MAC circuit 168 includes multipliers 178-0, 178-1, 178-2, and up to 178-N and an adder tree 180.

A memory array, such as memory array 22 or memory array 54, stores weight sets used in a neural network, and read circuits read the weight sets out of the memory array. The CIM circuit 160 receives weight sets of N+1 weights W from the memory array. Each of the weight buffer circuits 162-0, 162-1, and up to 162-N is configured to store one weight set of the weight sets. The write driver circuit 164 is configured to be connected to each of the weight buffer circuits 162-0, 162-1, and up to 162-N to write a weight set of N+1 weights W into each of the weight buffer circuits 162-0, 162-1, and up to 162-N. The write driver circuit 164 writes a weight set of N+1 weights W into one of the weight buffer circuits 162-0, 162-1, and up to 162-N during a single write clock cycle. In some embodiments, the memory array is an SRAM memory array. In some embodiments, the weights are for one of an LLM, an attention mechanism LLM, or a CNN.

The write driver circuit 164 writes a weight set of N+1 weights W into one of the weight buffer circuits 162-0, 162-1, and up to 162-N during a single write clock cycle. The write driver circuit 164 writes a weight set of N+1 weights W into the weight buffers 170-0, 170-1, 170-2, and up to 170-N during a single write clock cycle. To do this, word line WL₀ is activated, and the weight set of N+1 weights W is written into the weight buffers 170-0, 170-1, 170-2, and up to 170-N during a single write clock cycle. The weight buffers 170-0, 170-1, 170-2, and up to 170-N are selectively electrically connected to the sense amplifiers 176-0, 176-1, 176-2, and up to 176-N, respectively, that are electrically connected to the multipliers 178-0, 178-1, 178-2, and up to 178-N, respectively. The sense amplifiers 176-0, 176-1, 176-2, and up to 176-N, read the weight set of N+1 weights from the weight buffers 170-0, 170-1, 170-2, and up to 170-N and transmit each weight W to the corresponding multipliers 178-0, 178-1, 178-2, and up to 178-N. Each of the multipliers 178-0, 178-1, 178-2, and up to 178-N receives one data input of the data inputs XIN₀, XIN₁, XIN₂, and up to XIN_{N} and multiplies the one weight W and the one data input of the data inputs XIN₀, XIN₁, XIN₂, and up to XIN_{N} to provide a partial product. The adder tree 180 receives and sums the partial products from the multipliers 178-0, 178-1, 178-2, and up to 178-N and provides an accumulated result MAC. This can be or is repeated for each row of the multiple row weight buffer 162.

The write driver circuit 164 writes a weight set of N+1 weights W into the weight buffers 172-0, 172-1, 172-2, and up to 172-N during a single write clock cycle. To do this, word line WL₁ is activated, and the weight set of N+1 weights W is written into the weight buffers 172-0, 172-1, 172-2, and up to 172-N during a single write clock cycle. The weight buffers 172-0, 172-1, 172-2, and up to 172-N are selectively electrically connected to the sense amplifiers 176-0, 176-1, 176-2, and up to 176-N, respectively, that are electrically connected to the multipliers 178-0, 178-1, 178-2, and up to 178-N, respectively. The sense amplifiers 176-0, 176-1, 176-2, and up to 176-N, read the weight set of N+1 weights from the weight buffers 172-0, 172-1, 172-2, and up to 172-N and transmit each of the weights W to the corresponding one of the multipliers 178-0, 178-1, 178-2, and up to 178-N. Each of the multipliers 178-0, 178-1, 178-2, and up to 178-N receives one data input of the data inputs XIN₀, XIN₁, XIN₂, and up to XIN_{N} and multiplies the one weight W and the one data input of the data inputs XIN₀, XIN₁, XIN₂, and up to XIN_{N} to provide a partial product. The adder tree 180 receives and sums the partial products from the multipliers 178-0, 178-1, 178-2, and up to 178-N and provides an accumulated result MAC.

The write driver circuit 164 writes a weight set of N+1 weights W into the weight buffers 174-0, 174-1, 174-2, and up to 174-N during a single write clock cycle. To do this, word line WL_{N} is activated, and the weight set of N+1 weights W is written into the weight buffers 174-0, 174-1, 174-2, and up to 174-N during a single write clock cycle. The weight buffers 174-0, 174-1, 174-2, and up to 174-N are selectively electrically connected to the sense amplifiers 176-0, 176-1, 176-2, and up to 176-N, respectively, that are electrically connected to the multipliers 178-0, 178-1, 178-2, and up to 178-N, respectively. The sense amplifiers 176-0, 176-1, 176-2, and up to 176-N, read the weight set of N+1 weights from the weight buffers 174-0, 174-1, 174-2, and up to 174-N and transmit each of the weights W to the corresponding one of the multipliers 178-0, 178-1, 178-2, and up to 178-N. Each of the multipliers 178-0, 178-1, 178-2, and up to 178-N receives one data input of the data inputs XIN₀, XIN₁, XIN₂, and up to XIN_{N} and multiplies the one weight W and the one data input of the data inputs XIN₀, XIN₁, XIN₂, and up to XIN_{N} to provide a partial product. The adder tree 180 receives and sums the partial products from the multipliers 178-0, 178-1, 178-2, and up to 178-N and provides an accumulated result MAC.

Advantages of the CIM circuit 160 include updating an entire weight set into a weight buffer in a single write clock cycle, as opposed to multiple write clock cycles, which improves the weight update efficiency of the memory device for MAC operations.

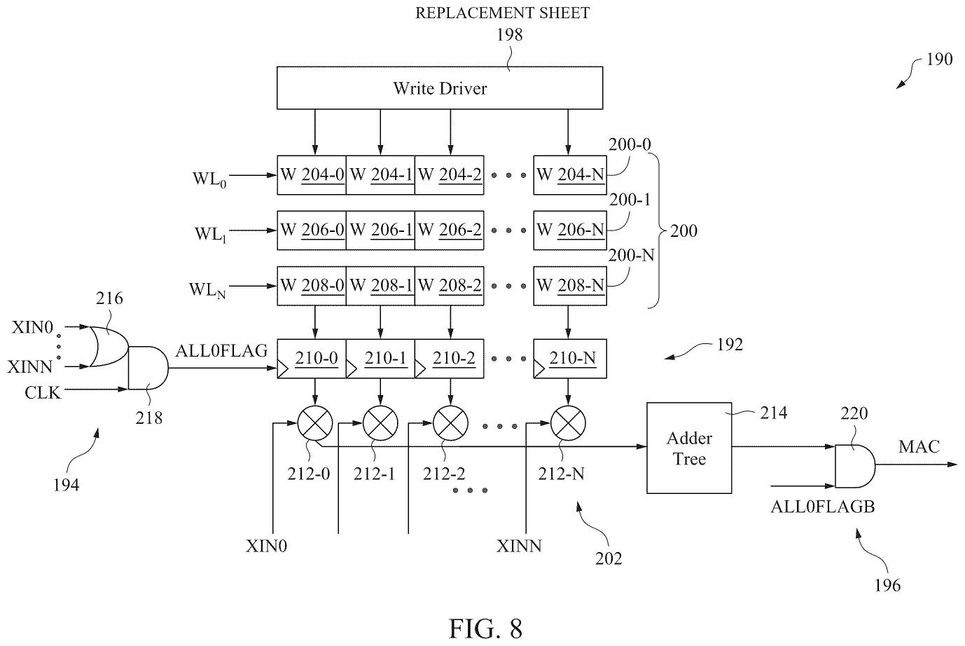

FIG. 8 is a diagram schematically illustrating a CIM circuit 190 that includes storage circuits 192, a zero skip circuit 194, and an all zero flag circuit 196, in accordance with some embodiments. The CIM circuit 190 improves the weight update efficiency of a memory device for MAC operations. In some embodiments, the memory device is like the memory device 20 of FIG. 1. In some embodiments, the memory device is like the CIM memory device 50 of FIG. 3. In some embodiments, the CIM circuit 190 is like the CIM circuit 36 shown in FIG. 1. In some embodiments, the CIM circuit 190 is like the CIM circuit 52 shown in FIG. 3.

The CIM circuit 190 includes a write driver circuit 198, a multiple row weight buffer 200, the storage circuits 192, a MAC circuit 202, the zero skip circuit 194, and the all zero flag circuit 196. The zero skip circuit 194 is configured to prevent clocking the weights W into the storage circuits 192 if all the data inputs XIN₀, XIN₁, XIN₂, and up to XIN_{N} are zero. Also, the all zero flag circuit 196 is configured to provide an accumulated result MAC of zero if all the data inputs XIN₀, XIN₁, XIN₂, and up to XIN_{N} are zero.

The multiple row weight buffer 200 includes weight buffer circuits 200-0, 200-1, and up to 200-N, where each row of the multiple row weight buffer 200 is a different weight buffer circuit of the weight buffer circuits 200-0, 200-1, and up to 200-N that is configured to store a weight set of N+1 weights W. The write driver circuit 198 writes a weight set of N+1 weights W into a row of the multiple row weight buffer 200 during a single clock cycle. some embodiments, the weight buffer circuits 200-0, 200-1, and up to 200-N are like the weight buffer circuits 38 shown in FIG. 1. In some embodiments, the MAC circuit 202 is like the MAC circuit 40 shown in FIG. 1. In some embodiments, each of the storage circuits 192 is a flip-flop. In some embodiments, each of the storage circuits 192 is a D flip-flop.

The weight buffer circuit 200-0 includes weight buffers 204-0, 204-1, 204-2, and up to 204-N. The weight buffer circuit 200-1 includes weight buffers 206-0, 206-1, 206-2, and up to 206-N, and up to the weight buffer circuit 200-N that includes weight buffers 208-0, 208-1, 208-2, and up to 208-N. Also, the storage circuits 192 include storage circuits 210-0, 210-1, 210-2, and up to 210-N. In addition, the MAC circuit 202 includes multipliers 212-0, 212-1, 212-2, and up to 212-N and an adder tree 214.

The zero skip circuit 194 includes an OR gate 216 that has inputs that receive the data inputs XIN₀, XIN₁, XIN₂, and up to XIN_{N} and an output that is electrically connected to an input of an AND gate 218. Another input of the AND gate 218 receives a clock signal CLK and an output ALL0FLAG of the AND gate 218 is electrically connected to each clock input of the storage circuits 210-0, 210-1, 210-2, and up to 210-N. Thus, the zero skip circuit 194 prevents clocking of the weights W from the weight buffer circuits 200-0, 200-1, and up to 200-N into the storage circuits 210-0, 210-1, 210-2, and up to 210-N if all of the data inputs XIN₀, XIN₁, XIN₂, and up to XIN_{N} are zero.

The all zero flag circuit 196 includes an AND gate 220 that receives an output from the adder tree 214 and an output ALL0FLAGB from the OR gate 216 and provides an accumulated result MAC of zero if all of the data inputs XIN₀, XIN₁, XIN₂, and up to XIN_{N} are zero. The zero skip circuit 194 and the all zero flag circuit 196 save power when the inputs are sparse, such as all zeros.

A memory array, such as memory array 22 or memory array 54, stores weight sets used in a neural network, and read circuits read the weight sets out of the memory array. The CIM circuit 190 receives weight sets of N+1 weights W from the memory array. Each of the weight buffer circuits 200-0, 200-1, and up to 200-N is configured to store one weight set of the weight sets. The write driver circuit 198 is configured to be connected to each of the weight buffer circuits 200-0, 200-1, and up to 200-N to write a weight set of N+1 weights W into each of the weight buffer circuits 200-0, 200-1, and up to 200-N. The write driver circuit 198 writes a weight set of N+1 weights W into one of the weight buffer circuits 200-0, 200-1, and up to 200-N during a single write clock cycle. In some embodiments, the memory array is an SRAM memory array. In some embodiments, the weights are for one of an LLM, an attention mechanism LLM, or a CNN.

The write driver circuit 198 writes a weight set of N+1 weights W into one of the weight buffer circuits 200-0, 200-1, and up to 200-N during a single write clock cycle. The write driver circuit 198 writes a weight set of N+1 weights W into the weight buffers 204-0, 204-1, 204-2, and up to 204-N during a single write clock cycle. To do this, word line WL₀ is activated, and the weight set of N+1 weights W is written into the weight buffers 204-0, 204-1, 204-2, and up to 204-N during a single write clock cycle. The weight buffers 204-0, 204-1, 204-2, and up to 204-N are selectively electrically connected to the storage circuits 210-0, 210-1, 210-2, and up to 210-N, respectively, that are electrically connected to the multipliers 212-0, 212-1, 212-2, and up to 212-N, respectively. If at least one of the data inputs XIN₀, XIN₁, XIN₂, and up to XIN_{N} is non-zero, the storage circuits 210-0, 210-1, 210-2, and up to 210-N clock in the weight set of N+1 weights from the weight buffers 204-0, 204-1, 204-2, and up to 204-N and transmit each weight W to the corresponding multipliers 212-0, 212-1, 212-2, and up to 212-N. Each of the multipliers 212-0, 212-1, 212-2, and up to 212-N receives one data input of the data inputs XIN₀, XIN₁, XIN₂, and up to XIN_{N} and multiplies the one weight W and the one data input of the data inputs XIN₀, XIN₁, XIN₂, and up to XIN_{N} to provide a partial product. The adder tree 214 receives and sums the partial products from the multipliers 212-0, 212-1, 212-2, and up to 212-N and provides an output to AND gate 220. If at least one of the data inputs XIN₀, XIN₁, XIN₂, and up to XIN_{N} is non-zero, the AND gate 220 provides the output from the adder tree 214 as the accumulated result MAC. If all the data inputs XIN₀, XIN₁, XIN₂, and up to XIN_{N} are zero, the AND gate 220 outputs an accumulated result MAC of zero. This can be or is repeated for each row of the multiple row weight buffer 200.

The write driver circuit 198 writes a weight set of N+1 weights W into the weight buffers 206-0, 206-1, 206-2, and up to 206-N during a single write clock cycle. To do this, word line WL₁ is activated, and the weight set of N+1 weights W is written into the weight buffers 206-0, 206-1, 206-2, and up to 206-N during a single write clock cycle. The weight buffers 206-0, 206-1, 206-2, and up to 206-N are selectively electrically connected to the storage circuits 210-0, 210-1, 210-2, and up to 210-N, respectively, that are electrically connected to the multipliers 212-0, 212-1, 212-2, and up to 212-N, respectively. If at least one of the data inputs XIN₀, XIN₁, XIN₂, and up to XIN_{N} is non-zero, the storage circuits 210-0, 210-1, 210-2, and up to 210-N clock in the weight set of N+1 weights from the weight buffers 206-0, 206-1, 206-2, and up to 206-N and transmit each weight W to the corresponding multipliers 212-0, 212-1, 212-2, and up to 212-N. Each of the multipliers 212-0, 212-1, 212-2, and up to 212-N receives one data input of the data inputs XIN₀, XIN₁, XIN₂, and up to XIN_{N} and multiplies the one weight W and the one data input of the data inputs XIN₀, XIN₁, XIN₂, and up to XIN_{N} to provide a partial product. The adder tree 214 receives and sums the partial products from the multipliers 212-0, 212-1, 212-2, and up to 212-N and provides an output to AND gate 220. If at least one of the data inputs XIN₀, XIN₁, XIN₂, and up to XIN_{N} is non-zero, the AND gate 220 provides the output from the adder tree 214 as the accumulated result MAC. If all the data inputs XIN₀, XIN₁, XIN₂, and up to XIN_{N} are zero, the AND gate 220 outputs an accumulated result MAC of zero.

The write driver circuit 198 writes a weight set of N+1 weights W into the weight buffers 208-0, 208-1, 208-2, and up to 208-N during a single write clock cycle. To do this, word line WL_{N} is activated, and the weight set of N+1 weights W is written into the weight buffers 208-0, 208-1, 208-2, and up to 208-N during a single write clock cycle. The weight buffers 208-0, 208-1, 208-2, and up to 208-N are selectively electrically connected to the storage circuits 210-0, 210-1, 210-2, and up to 208-N, respectively, that are electrically connected to the multipliers 212-0, 212-1, 212-2, and up to 212-N, respectively. If at least one of the data inputs XIN₀, XIN₁, XIN₂, and up to XIN_{N} is non-zero, the storage circuits 210-0, 210-1, 210-2, and up to 210-N clock in the weight set of N+1 weights from the weight buffers 208-0, 208-1, 208-2, and up to 208-N and transmit each weight W to the corresponding multipliers 212-0, 212-1, 212-2, and up to 212-N. Each of the multipliers 212-0, 212-1, 212-2, and up to 212-N receives one data input of the data inputs XIN₀, XIN₁, XIN₂, and up to XIN_{N} and multiplies the one weight W and the one data input of the data inputs XIN₀, XIN₁, XIN₂, and up to XIN_{N} to provide a partial product. The adder tree 214 receives and sums the partial products from the multipliers 212-0, 212-1, 212-2, and up to 212-N and provides an output to AND gate 220. If at least one of the data inputs XIN₀, XIN₁, XIN₂, and up to XIN_{N} is non-zero, the AND gate 220 provides the output from the adder tree 214 as the accumulated result MAC. If all the data inputs XIN₀, XIN₁, XIN₂, and up to XIN_{N} are zero, the AND gate 220 outputs an accumulated result MAC of zero.

Advantages of the CIM circuit 190 include updating an entire weight set into a weight buffer in a single write clock cycle, as opposed to multiple write clock cycles, which improves the weight update efficiency of the memory device for MAC operations. Also, the zero skip circuit 194 and the all zero flag circuit 196 save power when the data inputs XIN₀, XIN₁, XIN₂, and up to XIN_{N} are sparse, such as all zeros.

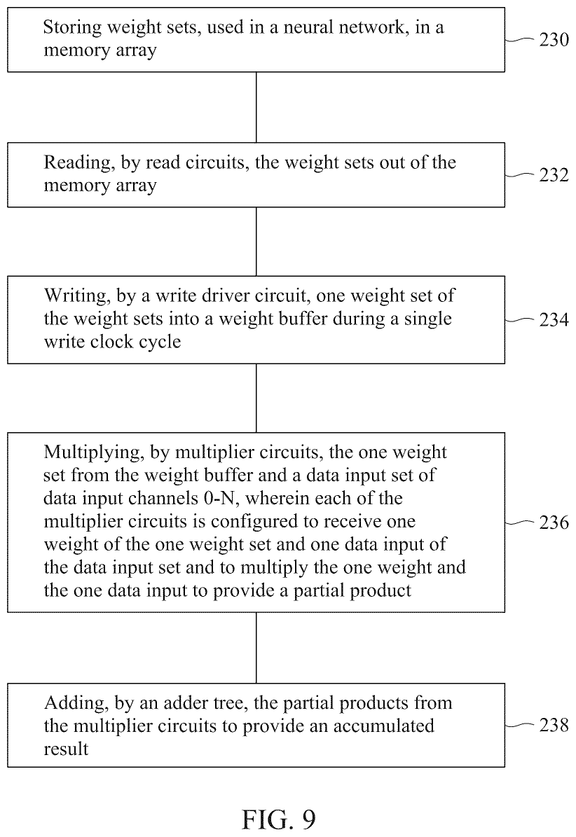

FIG. 9 is a diagram schematically illustrating a method of operating a neural network device, in accordance with some embodiments. In some embodiments, the neural network device is like the memory device 20 of FIG. 1. In some embodiments, the neural network device is like the CIM memory device 50 of FIG. 3. In some embodiments, the neural network device includes a CIM circuit like one of the CIM circuits 100, 160, and 190.

At 230, the method includes storing weight sets, used in a neural network, in a memory array. In some embodiments, the memory array is like the memory array 22. In some embodiments, the memory array is like the memory array 54.

At 232, the method includes reading, by read circuits, the weight sets out of the memory array. In some embodiments, the read circuits are like the read circuits 34 shown in FIGS. 1 and 2.

At 234, the method includes writing, by a write driver circuit, one weight set of the weight sets into a weight buffer during a single write clock cycle. In some embodiments, the write driver circuit is like one of the write driver circuits 102, 164, and 198. In some embodiments, the weight buffer is like one of the weight buffers 104-X shown in FIG. 5. In some embodiments, the weight buffer is like one of the weight buffers 162-X shown in FIG. 7. In some embodiments, the weight buffer is like one of the weight buffers 200-X shown in FIG. 8.

At 236, the method includes multiplying, by multiplier circuits, the one weight set from the weight buffer and a data input set of data input channels 0-N, wherein each of the multiplier circuits is configured to receive one weight of the one weight set and one data input of the data input set and to multiply the one weight and the one data input to provide a partial product. In some embodiments, the multiplier circuits are like the multipliers 62-X shown in FIG. 3. In some embodiments, the multiplier circuits are like the multipliers 114-X, 118-X, and 122-X shown in FIG. 5. In some embodiments, the multiplier circuits are like the multipliers 178-X shown in FIG. 7. In some embodiments, the multiplier circuits are like the multipliers 212-X shown in FIG. 8.

At 238, the method includes adding, by an adder tree, the partial products from the multiplier circuits to provide an accumulated result. In some embodiments, the adder tree is like the adder tree 64 shown in FIG. 3. In some embodiments, the adder tree is like one of the adder trees 116, 120, and 124 shown in FIG. 5. In some embodiments, the adder tree is like the adder tree 180 shown in FIG. 7. In some embodiments, the adder tree is like the adder tree 214 shown in FIG. 8.

In some embodiments, the method further includes writing, by the write driver circuit, a weight set of the weight sets into each row of a multiple row weight buffer that includes the weight buffer, wherein each row of the multiple row weight buffer is a different weight buffer that is configured to store the weight set during a single write clock cycle. In some embodiments, the multiple row weight buffer is like the multiple row weight buffer 172 shown in FIG. 7. In some embodiments, the multiple row weight buffer is like the multiple row weight buffer 200 shown in FIG. 8.

In some embodiments, the method further includes sensing, by sense amplifiers, the weight set from each row of the multiple row weight buffer, providing the weight set to the multiplier circuits, and multiplying, by the multiplier circuits, the weight set by a data input set of data input channels 0-N to provide partial products to the adder tree. In some embodiments, the sense amplifiers are like the sense amplifiers 166 shown in FIG. 7.

In some embodiments, the method further includes storing, by storage circuits, the weight set from each row of the multiple row weight buffer, providing the weight set to the multiplier circuits, and multiplying, by the multiplier circuits, the weight set by a data input set of data input channels 0-N to provide partial products to the adder tree. In some embodiments, the storage circuits are like the storage circuits 192 shown in FIG. 8.

In some embodiments, the method further includes receiving, by a zero skip circuit, the data input set of data input channels 0-N, preventing storage of the weight set in the storage circuits if all the data is zero in the data input set, and generating a zero accumulated result if all the data is zero in the data input set. In some embodiments, the zero skip circuit is like the zero skip circuit 194 shown in FIG. 8.

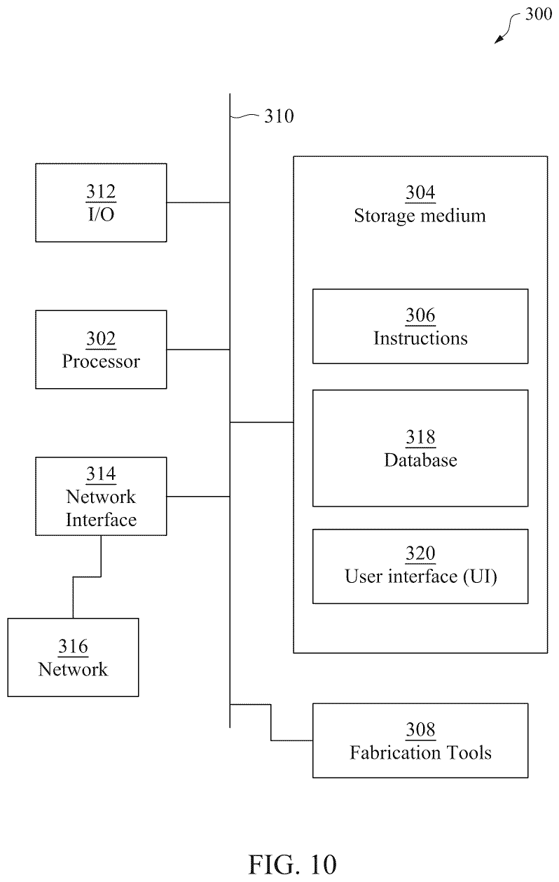

FIG. 10 is a block diagram schematically illustrating an example of a computer system 300 configured to provide the electronic devices, semiconductor devices, and methods of the current disclosure, in accordance with some embodiments. Some or all the design, layout, and manufacture of the semiconductor devices, also referred to as semiconductor circuits, can be performed by or with the aid of the computer system 300. Also, some or all the design, layout, and manufacture of the electronic devices can be performed by or with the aid of the computer system 300. In some embodiments, the computer system 300 includes an electronic design automation (EDA) system. In some embodiments, the semiconductor devices are ICs.

In some embodiments, the system 300 is a general-purpose computing device including a processor 302 and a non-transitory, computer-readable storage medium 304. The computer-readable storage medium 304 may be encoded with, e.g., store, computer program code such as executable instructions 306. Execution of the instructions 306 by the processor 302 provides (at least in part) a design tool that implements a portion or all the functions of the system 300, such as pre-layout simulations, post-layout simulations, routing, rerouting, and final layout for manufacturing. Further, fabrication tools 308 are included to further layout and physically implement the design and manufacture of the semiconductor devices. In some embodiments, execution of the instructions 306 by the processor 302 provides (at least in part) a design tool that implements a portion or all the functions of the system 300. In some embodiments, the system 300 includes a commercial router. In some embodiments, the system 300 includes an automatic place and route (APR) system.

The processor 302 is electrically coupled to the computer-readable storage medium 304 by a bus 310 and to an I/O interface 312 by the bus 310. A network interface 314 is also electrically connected to the processor 302 by the bus 310. The network interface 314 is connected to a network 316, so that the processor 302 and the computer-readable storage medium 304 can connect to external elements using the network 316. The processor 302 is configured to execute the computer program code or instructions 306 encoded in the computer-readable storage medium 304 to cause the system 300 to perform a portion or all the functions of the system 300, such as providing the semiconductor devices and methods of the current disclosure and other functions of the system 300. In some embodiments, the processor 302 is a central processing unit (CPU), a multi-processor, a distributed processing system, an application specific integrated circuit (ASIC), and/or a suitable processing unit.

In some embodiments, the computer-readable storage medium 304 is an electronic, magnetic, optical, electromagnetic, infrared, and/or semiconductor system or apparatus or device. For example, the computer-readable storage medium 304 can include a semiconductor or solid-state memory, a magnetic tape, a removable computer diskette, a random-access memory (RAM), a read-only memory (ROM), a rigid magnetic disk, and/or an optical disk. In some embodiments using optical disks, the computer-readable storage medium 304 can include a compact disk read only memory (CD-ROM), a compact disk read/write memory (CD-R/W), and/or a digital video disc (DVD).

In some embodiments, the computer-readable storage medium 304 stores computer program code or instructions 306 configured to cause the system 300 to perform a portion or all the functions of the system 300. In some embodiments, the computer-readable storage medium 304 also stores information which facilitates performing a portion or all the functions of the system 300. In some embodiments, the computer-readable storage medium 304 stores a database 318 that includes one or more of component libraries, digital circuit cell libraries, and databases.

The system 300 includes the I/O interface 312, which is coupled to external circuitry. In some embodiments, the I/O interface 312 includes a keyboard, keypad, mouse, trackball, trackpad, touchscreen, and/or cursor direction keys for communicating information and commands to the processor 302.

The network interface 314 is coupled to the processor 302 and allows the system 300 to communicate with the network 316, to which one or more other computer systems are connected. The network interface 314 can include: wireless network interfaces such as BLUETOOTH, WIFI, WIMAX, GPRS, or WCDMA; or wired network interfaces such as ETHERNET, USB, or IEEE-1364. In some embodiments, a portion or all the functions of the system 300 can be performed in two or more systems that are like system 300.

The system 300 is configured to receive information through the I/O interface 312. The information received through the I/O interface 312 includes one or more of instructions, data, design rules, libraries of components and cells, and/or other parameters for processing by the processor 302. The information is transferred to the processor 302 by the bus 310. Also, the system 300 is configured to receive information related to a user interface (UI) through the I/O interface 312. This UI information can be stored in the computer-readable storage medium 304 as a UI 320.

In some embodiments, a portion or all the functions of the system 300 are implemented via a standalone software application for execution by a processor. In some embodiments, a portion or all the functions of the system 300 are implemented in a software application that is a part of an additional software application. In some embodiments, a portion or all the functions of the system 300 are implemented as a plug-in to a software application. In some embodiments, at least one of the functions of the system 300 is implemented as a software application that is a portion of an EDA tool. In some embodiments, a portion or all the functions of the system 300 are implemented as a software application that is used by the system 300. In some embodiments, a layout diagram is generated using a tool such as VIRTUOSO available from CADENCE DESIGN SYSTEMS, Inc., or another suitable layout generating tool.

In some embodiments, the routing, layouts, and other processes are realized as functions of a program stored in a non-transitory computer readable recording medium. Examples of a non-transitory computer readable recording medium include, but are not limited to, external/removable and/or internal/built-in storage or memory units, e.g., one or more optical disks such as a digital video disc or a digital versatile disc (DVD), a magnetic disk such as a hard disk, a semiconductor memory such as a ROM and a RAM, and a memory card, and the like.

As noted above, embodiments of the system 300 include fabrication tools 308 for implementing the manufacturing processes of the system 300. For example, based on the final layout, photolithographic masks may be generated, which are used to fabricate the semiconductor device by the fabrication tools 308.

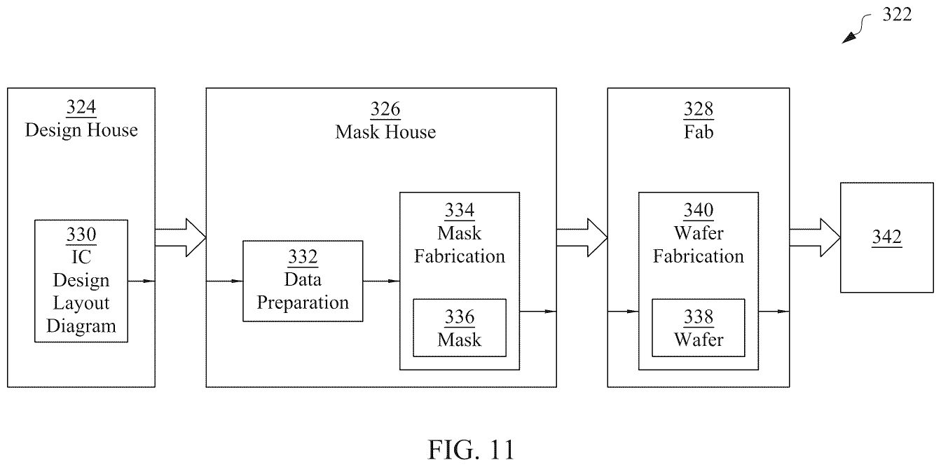

Further aspects of device fabrication are disclosed in conjunction with FIG. 11, which is a block diagram of a semiconductor device manufacturing system 322 and a semiconductor device manufacturing flow associated therewith, in accordance with some embodiments. In some embodiments, based on a layout diagram, one or more semiconductor masks and/or at least one component in a layer of a semiconductor device is fabricated using the manufacturing system 322.

In FIG. 11, the semiconductor device manufacturing system 322 includes entities, such as a design house 324, a mask house 326, and a semiconductor device manufacturer/fabricator (“Fab”) 328, that interact with one another in the design, development, and manufacturing cycles and/or services related to manufacturing a semiconductor device, such as the semiconductor devices described herein. The entities in the system 322 are connected by a communications network. In some embodiments, the communications network is a single network. In some embodiments, the communications network is a variety of different networks, such as an intranet and the internet. The communications network includes wired and/or wireless communication channels. Each entity interacts with one or more of the other entities and provides services to and/or receives services from one or more of the other entities. In some embodiments, two or more of the design house 324, the mask house 326, and the semiconductor device fab 328 are owned by a single larger company. In some embodiments, two or more of the design house 324, the mask house 326, and the semiconductor device fab 328 coexist in a common facility and use common resources.

The design house (or design team) 324 generates a semiconductor device design layout diagram 330. The semiconductor device design layout diagram 330 includes various geometrical patterns, or semiconductor device layout diagrams designed for a semiconductor device. The geometrical patterns correspond to patterns of metal, oxide, or semiconductor layers that make up the various components of the semiconductor structures to be fabricated. The various layers combine to form various semiconductor device features. For example, a portion of the semiconductor device design layout diagram 330 includes various semiconductor device features, such as diagonal vias, active areas or regions, gate electrodes, sources, drains, metal lines, local vias, and openings for bond pads, to be formed in a semiconductor substrate (such as a silicon wafer) and in various material layers disposed on the semiconductor substrate. The design house 324 implements a design procedure to form a semiconductor device design layout diagram 330. The semiconductor device design layout diagram 330 is presented in one or more data files having information of the geometrical patterns. For example, semiconductor device design layout diagram 330 can be expressed in a GDSII file format or DFII file format. In some embodiments, the design procedure includes one or more of analog circuit design, digital circuit design, logic circuit design, standard cell circuit design, power distribution network (PDN) design including power via design, supply voltage track design, reference voltage track design, place and route routines, and physical layout designs.

The mask house 326 includes data preparation 332 and mask fabrication 334. The mask house 326 uses the semiconductor device design layout diagram 330 to manufacture one or more masks 336 to be used for fabricating the various layers of the semiconductor device or semiconductor structure. The mask house 326 performs mask data preparation 332, where the semiconductor device design layout diagram 330 is translated into a representative data file (RDF). The mask data preparation 332 provides the RDF to the mask fabrication 334. The mask fabrication 334 includes a mask writer that converts the RDF to an image on a substrate, such as a mask (reticle) 336 or a semiconductor wafer 338. The design layout diagram 330 is manipulated by the mask data preparation 332 to comply with characteristics of the mask writer and/or criteria of the semiconductor device fab 328. In FIG. 11, the mask data preparation 332 and the mask fabrication 334 are illustrated as separate elements. In some embodiments, the mask data preparation 332 and the mask fabrication 334 can be collectively referred to as mask data preparation.

In some embodiments, the mask data preparation 332 includes an optical proximity correction (OPC) which uses lithography enhancement techniques to compensate for image errors, such as those that can arise from diffraction, interference, other process effects and the like. The OPC adjusts the semiconductor device design layout diagram 330. In some embodiments, the mask data preparation 332 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, the mask data preparation 332 includes a mask rule checker (MRC) that checks the semiconductor device design layout diagram 330 that has undergone processes in OPC with a set of mask creation rules which contain certain geometric and/or connectivity restrictions to ensure sufficient margins, to account for variability in semiconductor manufacturing processes, and the like. In some embodiments, the MRC modifies the semiconductor device design layout diagram 330 to compensate for limitations during the mask fabrication 334, which may undo part of the modifications performed by OPC to meet mask creation rules.

In some embodiments, the mask data preparation 332 includes lithography process checking (LPC) that simulates processing that will be implemented by the semiconductor device fab 328. LPC simulates this processing based on the semiconductor device design layout diagram 330 to create a simulated manufactured device. The processing parameters in LPC simulation can include parameters associated with various processes of the semiconductor device manufacturing cycle, parameters associated with tools used for manufacturing the semiconductor device, and/or other aspects of the manufacturing process. LPC considers various factors, such as aerial image contrast, depth of focus (“DOF”), mask error enhancement factor (“MEEF”), other suitable factors, and the like or combinations thereof. In some embodiments, after a simulated manufactured device has been created by LPC, if the simulated device is not close enough in shape to satisfy design rules, OPC and/or MRC are to be repeated to further refine the semiconductor device design layout diagram 330.

The above description of mask data preparation 332 has been simplified for the purposes of clarity. In some embodiments, data preparation 332 includes additional features such as a logic operation (LOP) to modify the semiconductor device design layout diagram 330 according to manufacturing rules. Additionally, the processes applied to the semiconductor device design layout diagram 330 during data preparation 332 may be executed in a variety of different orders.

After the mask data preparation 332 and during the mask fabrication 334, a mask 336 or a group of masks 336 are fabricated based on the modified semiconductor device design layout diagram 330. In some embodiments, the mask fabrication 334 includes performing one or more lithographic exposures based on the semiconductor device design layout diagram 330. In some embodiments, an electron-beam (e-beam) or a mechanism of multiple e-beams is used to form a pattern on a mask (photomask or reticle) 336 based on the modified semiconductor device design layout diagram 330. The mask 336 can be formed in various technologies. In some embodiments, the mask 336 is formed using binary technology. In some embodiments, a mask pattern includes opaque regions and transparent regions. A radiation beam, such as an ultraviolet (UV) beam, used to expose the image sensitive material layer (e.g., photoresist) which has been coated on a wafer, is blocked by the opaque region, and transmits through the transparent regions. In one example, a binary mask version of the mask 336 includes a transparent substrate (e.g., fused quartz) and an opaque material (e.g., chromium) coated in the opaque regions of the binary mask. In another example, the mask 336 is formed using a phase shift technology. In a phase shift mask (PSM) version of the mask 336, various features in the pattern formed on the phase shift mask are configured to have proper phase difference to enhance the resolution and imaging quality. In various examples, the phase shift mask can be attenuated PSM or alternating PSM. The mask(s) generated by the mask fabrication 334 is used in a variety of processes. For example, such a mask(s) is used in an ion implantation process to form various doped regions in the semiconductor wafer 338, in an etching process to form various etching regions in the semiconductor wafer 338, and/or in other suitable processes.

The semiconductor device fab 328 includes wafer fabrication 340. The semiconductor device fab 328 is a semiconductor device fabrication business that includes one or more manufacturing facilities for the fabrication of a variety of different semiconductor device products. In some embodiments, the semiconductor device fab 328 is a semiconductor foundry. For example, there may be a manufacturing facility for the front end of line (FEOL) fabrication of a plurality of semiconductor device products, while a second manufacturing facility may provide the BEOL fabrication for the interconnection and packaging of the semiconductor device products, and a third manufacturing facility may provide other services for the foundry business.

The semiconductor device fab 328 uses the mask(s) 336 fabricated by the mask house 326 to fabricate the semiconductor structures or semiconductor devices 342 of the current disclosure. Thus, the semiconductor device fab 328 at least indirectly uses the semiconductor device design layout diagram 330 to fabricate the semiconductor structures or semiconductor devices 342 of the current disclosure. Also, the semiconductor wafer 338 includes a silicon substrate or other proper substrate having material layers formed thereon, and the semiconductor wafer 338 further includes one or more of various doped regions, dielectric features, multilevel interconnects, and the like (formed at subsequent manufacturing steps). In some embodiments, the semiconductor wafer 338 is fabricated by the semiconductor device fab 328 using the mask(s) 336 to form the semiconductor structures or semiconductor devices 342 of the current disclosure. In some embodiments, the semiconductor device fabrication includes performing one or more lithographic exposures based at least indirectly on the semiconductor device design layout diagram 330.

Disclosed embodiments thus provide a device that improves the weight update efficiency for MAC operations. The device includes a memory array that stores weight sets used in an artificial neural network and read circuits configured to read the weight sets out of the memory array. A weight buffer is configured to store one weight set of the weight sets, and a write driver circuit is configured to write the one weight set into the weight buffer during a single write clock cycle. Multiplier circuits are configured to receive a weight set from the weight buffer and a data input set of data input channels 0-N. Each of the multiplier circuits is configured to receive one weight W of the weight set and one data input of the data input set and to multiply the one weight W and the one data input to provide a partial product. An adder tree sums the partial products from the multiplier circuits and provides an accumulated result.

Disclosed embodiments further provide a method of operating a neural network device that includes storing weight sets in a memory array; reading the weight sets out of the memory array; writing one weight set of the weight sets into a weight buffer during a single write clock cycle; multiplying the one weight set from the weight buffer and a data input set of data input channels 0-N, wherein each of the multiplier circuits receives one weight of the one weight set and one data input of the data input set and multiplies the one weight and the one data input to provide a partial product; and adding the partial products from the multiplier circuits to provide an accumulated result.

Advantages of the disclosed embodiments include updating an entire weight set into a weight buffer in a single write clock cycle, as opposed to multiple write clock cycles, which improves the weight update efficiency of the memory devices for MAC operations. Also, saving power by using zero skip circuits and all zero flag circuits when all the data inputs are zeros.

In accordance with some embodiments, a device includes a memory array configured to store a plurality of weight sets used in a neural network and read circuits configured to read the plurality of weight sets out of the memory array. A first weight buffer is configured to store a first weight set of the plurality of weight sets in the first weight buffer, and a write driver circuit is configured to write the first weight set into the first weight buffer during a single write clock cycle. A plurality of first multiplier circuits are configured to receive the first weight set from the first weight buffer and a first data input set of data input channels 0-N. Each of the first multiplier circuits is configured to receive a corresponding first weight of the first weight set and a first data input of the first data input set, and to multiply the first weight and the first data input to provide a partial product. An adder tree is configured to sum the partial products from the first multiplier circuits and provide an accumulated result.

In accordance with further embodiments, a device includes a memory array that stores weight sets used in a neural network, read circuits configured to read the weight sets out of the memory array, and a multiple row weight buffer, wherein each row of the multiple row weight buffer is a different weight buffer that is configured to store a weight set of the weight sets. A write driver circuit is configured to write the weight set into the different weight buffer during a single write clock cycle. Multiplier circuits are configured to receive the weight set from each row of the multiple row weight buffer and a corresponding data input set of data input channels 0-N, wherein each of the multiplier circuits is configured to receive one weight of the weight set and one data input of the corresponding data input set and to multiply the one weight and the one data input to provide a partial product. An adder tree is configured to sum the partial products from the multiplier circuits and provide an accumulated result.

In accordance with still further disclosed aspects, a method of operating a neural network device includes: storing weight sets, used in a neural network, in a memory array; reading, by read circuits, the weight sets out of the memory array; writing, by a write driver circuit, one weight set of the weight sets into a weight buffer during a single write clock cycle; multiplying, by multiplier circuits, the one weight set from the weight buffer and a data input set of data input channels 0-N, wherein each of the multiplier circuits is configured to receive one weight of the one weight set and one data input of the data input set and to multiply the one weight and the one data input to provide a partial product; and adding, by an adder tree, the partial products from the multiplier circuits to provide an accumulated result.

This disclosure outlines various embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A device, comprising:
a memory array configured to store a plurality of weight sets used in a neural network;
read circuits configured to read the plurality of weight sets out of the memory array;
a first weight buffer configured to store a first weight set of the plurality of weight sets in the first weight buffer;
a write driver circuit configured to write the first weight set into the first weight buffer during a single write clock cycle;
a plurality of first multiplier circuits configured to receive the first weight set from the first weight buffer and a first data input set of data input channels 0-N, wherein each of the first multiplier circuits is configured to receive a corresponding first weight of the first weight set and a first data input of the first data input set, and to multiply the first weight and the first data input to provide a partial product; and
an adder tree configured to sum the partial products from the first multiplier circuits and provide an accumulated result.

2. The device of claim 1, comprising;
a second weight buffer configured to store a second weight set of the plurality of weight sets in the second weight buffer, wherein the write driver circuit is configured to write the second weight set into the second weight buffer during another single write clock cycle; and
a plurality of second multiplier circuits configured to receive the second weight set from the second weight buffer and a second data input set of data input channels 0-N, wherein each of the second multiplier circuits is configured to receive a corresponding second weight of the second weight set and a second data input of the second data input set, and to multiply the second weight of the second weight set and the second data input of the second data input set to provide another partial product.

3. The device of claim 1, comprising:
a multiple row weight buffer that includes the first weight buffer, wherein each row of the multiple row weight buffer is configured to store a weight set of the plurality of weight sets and the write driver circuit is configured to write the weight set into each row of the multiple row weight buffer during a corresponding single write clock cycle.

4. The device of claim 3, comprising:
sense amplifiers configured to read the weight set from each row of the multiple row weight buffer and provide the weight set to the first multiplier circuits of the plurality of first multiplier circuits and the first multiplier circuits are configured to multiply the weight set by a data set of data input channels 0-N to provide partial products to the adder tree.

5. The device of claim 3, comprising:
storage circuits configured to store the weight set from each row of the multiple row weight buffer and provide the weight set to the first multiplier circuits of the plurality of first multiplier circuits and the first multiplier circuits are configured to multiply the weight set by a data set of data input channels 0-N to provide partial products to the adder tree.

6. The device of claim 5, wherein the storage circuits are flip flops.

7. The device of claim 5, comprising a zero skip circuit configured to receive the data set of data input channels 0-N and prevent storage of the weight set in the storage circuits if all the data in the data set is zero.

8. The device of claim 5, comprising an all zero flag circuit that provides a zero accumulated result if all the data in the data set is zero.

9. The device of claim 1, wherein the memory array is an SRAM memory array.

10. The device of claim 1, wherein the weights are for one of an attention mechanism oriented large language model or a convolutional neural network.

11. A device, comprising:
a memory array that stores weight sets used in a neural network;
read circuits configured to read the weight sets out of the memory array;
a multiple row weight buffer, wherein each row of the multiple row weight buffer is a different weight buffer that is configured to store a weight set of the weight sets;
a write driver circuit configured to write the weight set into the different weight buffer during a single write clock cycle;
multiplier circuits configured to receive the weight set from each row of the multiple row weight buffer and a corresponding data input set of data input channels 0-N, wherein each of the multiplier circuits is configured to receive one weight of the weight set and one data input of the corresponding data input set and to multiply the one weight and the one data input to provide a partial product; and
an adder tree configured to sum the partial products from the multiplier circuits and provide an accumulated result.

12. The device of claim 11, comprising:
sense amplifiers configured to read the weight set from each row of the multiple row weight buffer and provide the weight set to the multiplier circuits.

13. The device of claim 11, comprising:
storage circuits configured to store the weight set from each row of the multiple row weight buffer and provide the weight set to the multiplier circuits.

14. The device of claim 13, comprising a zero skip circuit configured to receive the corresponding data input set and prevent storage of the weight set in the storage circuits if all of the data is zero in the corresponding data input set.

15. The device of claim 13, comprising an all zero flag circuit that provides a zero accumulated result if all of the data is zero in the corresponding data input set.

16. A method of operating a neural network device, the method comprising:
storing weight sets, used in a neural network, in a memory array;
reading, by read circuits, the weight sets out of the memory array;
writing, by a write driver circuit, one weight set of the weight sets into a weight buffer during a single write clock cycle;
multiplying, by multiplier circuits, the one weight set from the weight buffer and a data input set of data input channels 0-N, wherein each of the multiplier circuits is configured to receive one weight of the one weight set and one data input of the data input set and to multiply the one weight and the one data input to provide a partial product; and
adding, by an adder tree, the partial products from the multiplier circuits to provide an accumulated result.

17. The method of claim 16, comprising:
writing, by the write driver circuit, a weight set of the weight sets into each row of a multiple row weight buffer that includes the weight buffer, wherein each row of the multiple row weight buffer is a different weight buffer that is configured to store the weight set during a single write clock cycle.

18. The method of claim 17, comprising:
sensing, by sense amplifiers, the weight set from each row of the multiple row weight buffer;
providing the weight set to the multiplier circuits; and
multiplying, by the multiplier circuits, the weight set by a data input set of data input channels 0-N to provide partial products to the adder tree.

19. The method of claim 17, comprising:
storing, by storage circuits, the weight set from each row of the multiple row weight buffer;
providing the weight set to the multiplier circuits; and
multiplying, by the multiplier circuits, the weight set by a data input set of data input channels 0-N to provide partial products to the adder tree.

20. The method of claim 19, comprising:
receiving, by a zero skip circuit, the data input set of data input channels 0-N;
preventing storage of the weight set in the storage circuits if all the data is zero in the data input set; and
generating a zero accumulated result if all the data is zero in the data input set.
